(19) United States
(12) Patent Application Publication
(10) Pub. No.: US 2011/0246493 A1
(43) Pub. Date: Oct. 6, 2011

(54) SYSTEMS, METHODS AND INTERFACES FOR ANALYZING ELECTRONIC FILES

(76) Inventor: Sean M. Walker, Apple Valley, MN (US)

(21) Appl. No.: 12/750,818

(22) Filed: Mar. 31, 2010

(51) Int. Cl. G06F 17/30

(52) U.S. Cl. 707/758; 707/803; 707/E17.005; 707/E17.014

(57) ABSTRACT

A computer-implemented method for analyzing electronic files includes receiving at least one electronic file. The at least one electronic file is associated with at least one pattern and determining if the at least one pattern is recognized. If the pattern is not recognized, creating a record for at least one unrecognized pattern, including relating the at least one unrecognized pattern to at least one associated electronic file, within a storage mechanism. If the pattern is recognized, relating at least one recognized pattern to at least one associated electronic file within the storage mechanism. And querying the storage mechanism based on at least one criteria, generating a signal associated with a set of results based on the at least one criteria and transmitting the signal associated with the set of results.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright© 2010, Thomson Reuters.

### FIELD OF INVENTION

Various embodiments of the present invention concern systems, methods and interfaces for analyzing electronic files and their structure.

### BACKGROUND OF THE INVENTION

In the today's world, people receive and send electronic files (i.e. documents, audio, video, etc.) in various structures every day. A developer might handle documents in XML (Extensible Markup Language), HTML (Hypertext Markup Language) and/or JavaScript; whereas a lawyer might only handle documents in Microsoft®Word and/or PDF. And each of these files has its own structure. So when one is given the task of analyzing the structure of these electronic files, the task seems insurmountable. This is especially applicable in the legal publishing realm. Each jurisdiction has a different format or structure for their opinions, statutes, secondary sources, etc. which can lead to thousands if not millions of different structures to analyze. Additionally, the analysis process of legal document structure and content is a labor intensive process that can be subjective and inaccurate when manually inspecting and extrapolating results from a small pool of documents. Since it would be impractical to manually inspect and extrapolate results from all documents or even a large sampling of documents, there is a need for a better way of processing the data and determining a way to categorize and display a vast library of documents.

Accordingly, the present inventors have recognized a need for improvement of systems, methods and interfaces for analyzing electronic files. In one exemplary embodiment, the present invention analyzes the electronic files and their structures to aid a user that is testing the display of electronic files.

### SUMMARY OF THE INVENTION

The invention is a computer-implemented method and system for analyzing electronic files that includes receiving at least one electronic file associated with at least one pattern and determining if the pattern is recognized. If the pattern is not recognized, a record is created for the unrecognized pattern, including relating the unrecognized pattern to the electronic file within a storage mechanism. If it is recognized, relating the recognized pattern to the electronic file. The invention also allows for querying the storage mechanism based on at least one criteria and rendering a set of results based on the at least one criteria.

### BRIEF DESCRIPTION OF THE DRAWINGS

FIG. 1 is a diagram of an exemplary system for analyzing electronic files 100 corresponding to one or more embodiments of the invention;

FIG. 2a is an exemplary interface 200a corresponding to one or more embodiments of the invention, in particular, loading a set of electronic files;

FIG. 2 is a process flow 200 corresponding to one or more exemplary methods of operating system and one or more embodiments of the invention;

FIG. 3 is an exemplary interface 300 corresponding to one or more embodiments of the invention in particular, selecting mappings for a content type;

FIG. 4 is an exemplary interface 400 corresponding to one or more embodiments of the invention in particular, adding/editing a content type.

FIG. 5 is a diagram of an exemplary data model 500 corresponding to one or more embodiments of the invention;

FIG. 6 is an exemplary interface 600 corresponding to one or more embodiments of the invention in particular, querying a database of analyzed electronic files;

FIG. 7 is an exemplary interface 700 corresponding to one or more embodiments of the invention in particular, querying a database of analyzed electronic files;

FIGS. 7a-e are exemplary interfaces 700a-e corresponding to one or more embodiments of the invention in particular, displaying an electronic file to the user in various views;

FIG. 8 is an exemplary interface 800 corresponding to one or more embodiments of the invention in particular, querying a database of analyzed electronic files;

FIG. 9 is an exemplary interface 900 corresponding to one or more embodiments of the invention in particular, querying a database of analyzed electronic files; and

FIG. 10 is an exemplary interface 1000 corresponding to one or more embodiments of the invention in particular, querying a database of analyzed electronic files.

### DETAILED DESCRIPTION OF THE EXEMPLARY EMBODIMENTS

This description, which references and incorporates the above-identified Figures, describes one or more specific embodiments of one or more inventions. These embodiments, offered not to limit but only to exemplify and teach the one or more inventions, are shown and described in sufficient detail to enable those skilled in the art to implement or practice the invention. Thus, where appropriate to avoid obscuring the invention, the description may omit certain information known to those of skill in the art.

The description includes many terms with meanings derived from their usage in the art or from their use within the context of the description. However, as a further aid, the following exemplary definitions are presented. The term “electronic files” refers to documents, text files, audio files, video files, image files or any type of file which is available to a computer program. The term “structure” refers to a type of delimiter that patterns can be parsed from. Examples of structures include but are not limited to XML, HTML, etc. Further examples of structure and pattern are described throughout the specification.

### Exemplary System for Analyzing Electronic Files

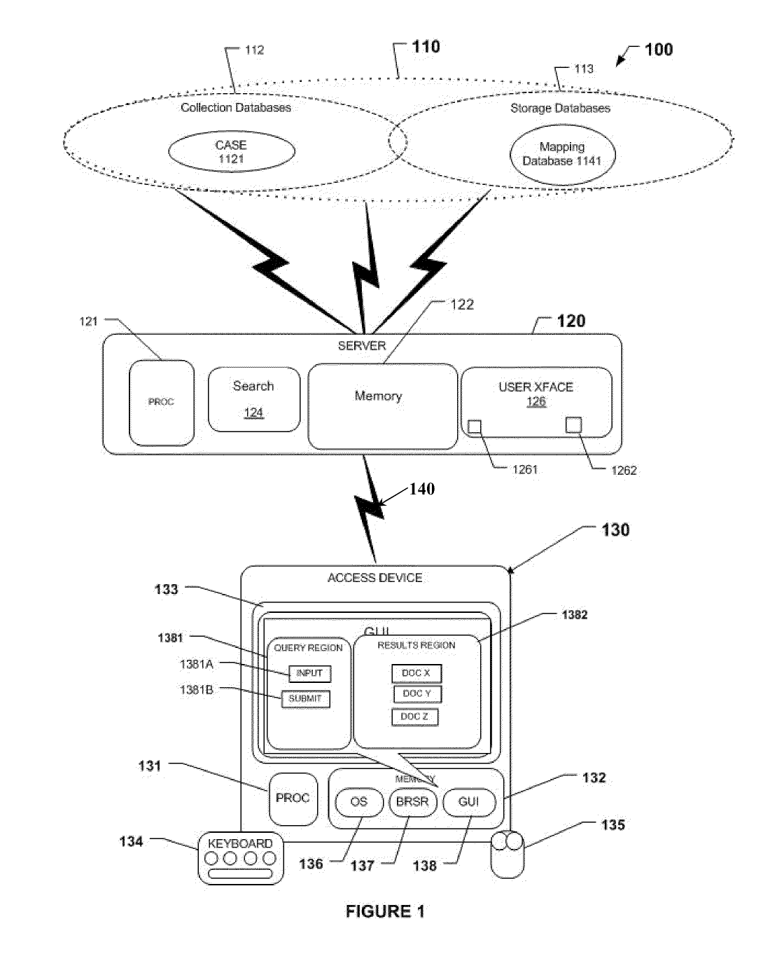

FIG. 1 shows an exemplary system for analyzing electronic files 100, which may be adapted to incorporate the capabilities, functions, methods, interfaces, and so forth described above. System 100 includes one or more databases 110, one or more servers 120, and one or more access devices 130.

Databases 110 comprise a set of collection databases 112 and a set of storage databases 113. Collection databases 112, in the exemplary embodiment, include a caselaw database 1121. In other embodiments, the collections database 112 additionally includes statutes, secondary professional resources, expert testimony, patents, scientific literature, financial data, such as public stock market data, news data or any type of file that contains a structure. Storage databases 113, in the exemplary embodiment, include a mapping database 1141. This mapping database 1141 stores information regarding recognized patterns, document identifiers (GUIDs or globally unique identifiers), mapping elements, content types, and the mappings between the information listed previously in this sentence. Other embodiments may include non-legal databases that include financial, scientific, health-care, market, news or professional information. Still other embodiments provide public or private databases. Databases 110, which take the exemplary form of one or more electronic, magnetic, or optical data-storage devices, also comprise or are otherwise associated with respective indices (not shown). Each of the indices includes terms and phrases in association with corresponding document addresses, identifiers, and other conventional information. Databases 110 are coupled or couplable via a wireless or wireline communications network, such as a local-, wide-, private-, or virtual-private network, to server 120.

Server 120, which is generally representative of one or more servers for serving data in the form of webpages or other markup language forms with associated applets, ActiveX controls, remote-invocation objects, or other related software and data structures to service clients of various “thicknesses.” A client which depends heavily on some other computer for computational activities is considered to be a “thin” client. A client that has the ability to perform many functions without a continuous connection to a network or central server is considered to be a “thick” client. In addition, server 120 generates a signal and transmits that signal 140 over a wireless or wireline communications network on one or more accesses devices, such as access device 130. For example, a signal may be associated with a set of results after querying a mapping database 1141. More particularly, server 120 includes a processor module 121, a memory module 122, a search module 124 and a user-interface module 126.

Processor module 121 includes one or more local or distributed processors, controllers, or virtual machines. In the exemplary embodiment, processor module 121 assumes any convenient or desirable form. Memory module 122, which takes the exemplary form of one or more electronic, magnetic, or optical data-storage devices, stores the search module 124 and the user-interface module 126. Search module 124 includes one or more search engines and related user-interface components, for receiving and processing user queries against one or more of databases 110. User-interface module 126 includes machine readable and/or executable instruction sets for wholly or partly defining web-based user interfaces, such as search interface 1261 and results interface 1262, over a wireless or wireline communications network on one or more accesses devices, such as access device 130.

Access device 130 is generally representative of one or more access devices. In the exemplary embodiment, access device 130 takes the form of a personal computer, workstation, personal digital assistant, mobile telephone, or any other device capable of providing an effective user interface with a server or database. Specifically, access device 130 includes a processor module 131, one or more processors (or processing circuits) 131, a memory 132, a display 133, a keyboard 134, and a graphical pointer or selector 135.

Processor module 131 includes one or more processors, processing circuits, or controllers. In the exemplary embodiment, processor module 131 takes any convenient or desirable form. Coupled to processor module 131 is memory 132.

Memory 132 stores code (machine-readable or executable instructions) for an operating system 136, a browser 137, and a graphical user interface (GUI) 138. In the exemplary embodiment, operating system 136 takes the form of a version of the Microsoft Windows operating system, and browser 137 takes the form of a version of Microsoft Internet Explorer. Operating system 136 and browser 137 not only receive inputs from keyboard 134 and selector 135, but also support rendering of GUI 138 on display 133. Upon rendering, GUI 138 presents data in association with one or more interactive control features (or user-interface elements).

In the exemplary embodiment, each of these control features takes the form of a hyperlink or other browser-compatible command input, and provides access to and control of query region 1381 and search-results region 1382. User selection of the control features in region 1382 results in retrieval and display of at least a portion of the corresponding document within a region of interface 138 (not shown in this figure.) Although FIG. 1 shows region 1381 and 1382 as being simultaneously displayed, some embodiments present them at separate times.

### Exemplary Method for Analyzing Electronic Files

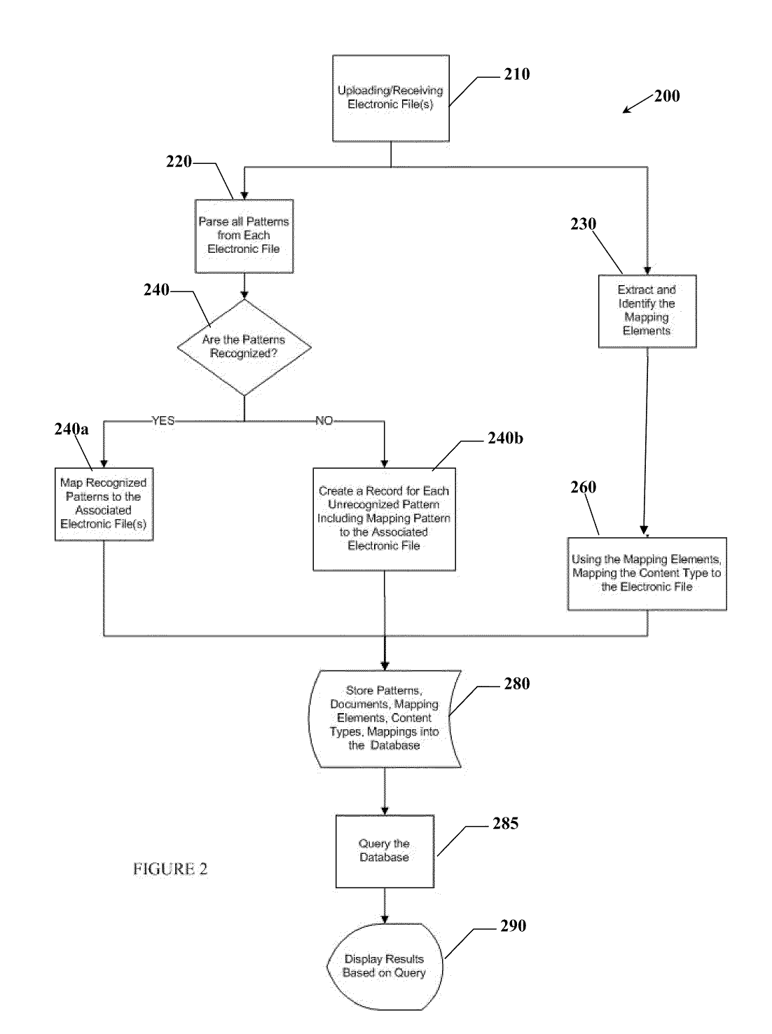

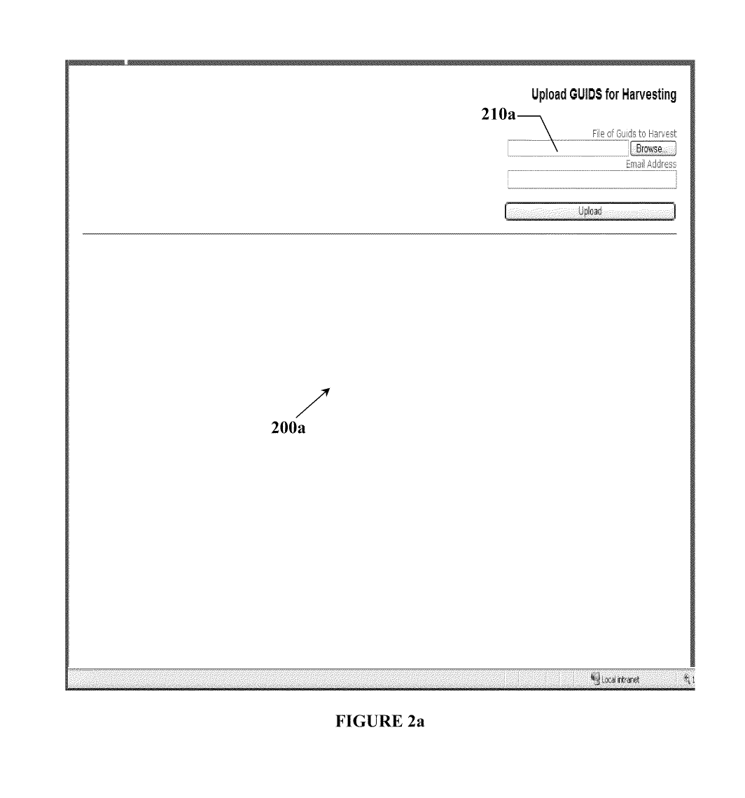

FIG. 2 shows a process flow 200 of one or more exemplary methods of operating a system, such as system 100. Process flow 200 includes tasks 210-290, which, like other tasks in this description, are arranged and described in a serial sequence in the exemplary embodiment.

### Selecting Samples of Electronic Files to Analyze

When selecting samples of electronic files to be analyzed, a number of sampling methods could be used to select the number of electronic files needed. This selection process is very analogous to the sampling rates used in political polls, where the consistency of the field is determined and an appropriate sampling rate is determined. A list of special case and sampled electronic files are assembled for analysis. A listing of special case electronic files is either done manually or programmatically wherein a program runs through the electronic files and makes a determination on which electronic files should be considered special case. A determination of the number of additional electronic files that needs to be sampled is a function of inspecting potential collections (i.e. databases), determining the sampling rate and selecting the sampled electronic files based on a random selection routine. Once the specific list of electronic files is determined, an exemplary computer-implemented process flow 200 begins by uploading and receiving the electronic files. For example, FIG. 2a depicts a user interface where a user uploads the electronic files 210 through a device 210a. Examples of devices include but are not limited to flash drive, external or internal storage device or some type of wired or wireless network transfers. Additionally, the device does not have to contain the actual document. As long as the device is capable of assisting with providing access to the document (via URL, document ID, etc.), the electronic files are uploaded 210. After the specific list of electronic files is uploaded, the mapping of the patterns to the electronic files begins.

### Analyze and Map Electronic Files to Patterns

In an exemplary embodiment, when the electronic files are being uploaded 210, the structure of each file is also being uploaded. An example of a structure is hierarchical markup language such as XML. The structure loading allows for parsing of any patterns that exist within the structure of the electronic file 220. For example, the structure pictured below is an XML structure of an electronic file.

```
- <html>
  - <head>
    <title>title</title>
  </head>
  - <body>
  - <div class=“oneclass=”>
    - <div class=“twoclass=”>
    - <div class=“threeclass=”>
      - <div class=“fourclass=”>
      - <div class=“fiveclass=”>
        Mauris tempus, turpis eu luctus sagittis, ipsum elit porta enim,
        non lobortis lacus velit vitae lorem.
        <span class=“co_searchTerm”>SearchTerm1</span>
        Nunc id metus et ante consequatmattis.
        </div>
      </div>
      </div>
    </div>
    </div>
  - <div class=“oneClass2”>
    - <div class=“twoClass2”>
    - <div class=“threeClass2”>
      - <div class=“fourClass2”>
      - <div class=“fiveClass2”>
        Mauris tempus, turpis eu luctus sagittis, ipsum elit porta enim,
        non lobortis lacus velit vitae lorem.
        <span class=“co_searchTerm”>SearchTerm2</span>
        Nunc id metus et ante consequat mattis.
        </div>
      </div>
      - <div class=“fourClass3”>
      - <div class=“fiveClass3”>
        Mauris tempus, turpis eu luctus sagittis, ipsum elit porta enim,
        non lobortis lacus velit vitaelorem.
        <span class=“co_searchTerm”>SearchTerm3</span>
        Nunc id metus et ante consequat mattis.
        </div>
      </div>
      </div>
    </div>
    </div>
  </body>
  </html>
```

Given this XML structure, the following patterns are parsed from the structure using various techniques known to those of ordinary skill in the art:

/html
/html/head
/html/head/title
/html/body/div
/html/body/div/div
/html/body/div/div/div
/html/body/div/div/div/div
/html/body/div/div/div/div/div
/html/body/div/div/div/div/div/span

In the exemplary embodiment of the patterns above, notice that some patterns are repeated within the structure but each unique pattern is listed only once. In another embodiment, a record is kept of how many times each pattern is cited not only within each electronic file but within a collection of electronic files, for later use in analyzing the electronic files.

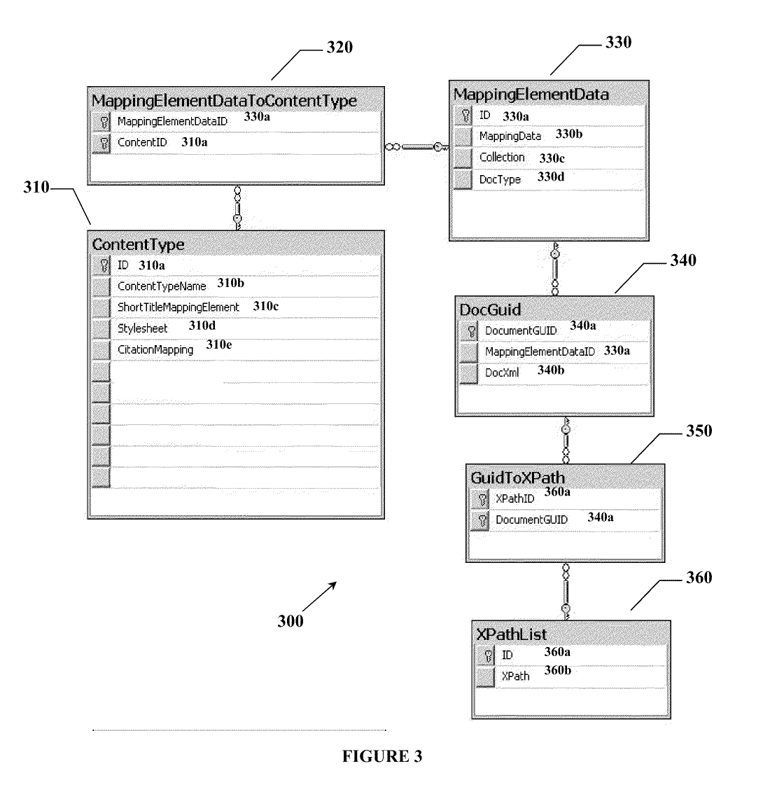

After parsing, a determination 240 is made as to whether or not each pattern already exists within a database of recognized patterns (e.g., mapping database 1141). If the determination is that the pattern exists (i.e., a recognized pattern), a mapping occurs between the pattern ID and the document ID 240a and stored 280 in the database of recognized patterns 1141. When an example makes reference to a document ID, it references an ID given to an electronic file as a document is an exemplary type of electronic file. If the determination is that the pattern did not exist (i.e., an unrecognized pattern), a record of each unrecognized pattern is created 240b and added to and stored in 280 the database of recognized patterns 1141. In the exemplary embodiment of FIG. 3, a synonymous name for a pattern is)(Path. Here the)(Path either already has an ID 360a because the pattern already existed or the application gives the pattern a new ID if the pattern is unrecognized. The electronic files containing these patterns each have GUIDs 340a. Whether the)(Path is recognized or unrecognized, the mapping between the)(Path ID and the electronic file 350 is stored 280 within the database of recognized patterns 1141. In one exemplary embodiment, each unique pattern has only one)(Path ID 360a. Therefore when a pattern is determined as recognized, a mapping to the additional electronic file occurs while the XPath ID remains the same. However, another exemplary embodiment gives each pattern regardless of its uniqueness an XPath ID.

### Analyze and Map Electronic Files to Content Type

In some exemplary embodiments, referring again to FIG. 3, a set of electronic files that have been mapped to patterns 240a-b are also mapped to a content type using mapping element data 260. Here the XPath has an ID 360a because the pattern already existed. The document containing the pattern has a GUID 340a. This mapping between the XPath ID and the GUID 650 is stored 280 within the mapping database 1141. Additionally, the document is mapped to a content type 310 through mapping elements 320. In the present example, the mapping elements 330 include the collection 330c and the doc type 330d. These elements are collectively given a mapping element data ID 330a. The mapping between the mapping element data ID and a ContentID 320 are stored 280 within the mapping database 1141 as well as the mapping between the mapping element data ID and the doc GUID 350.

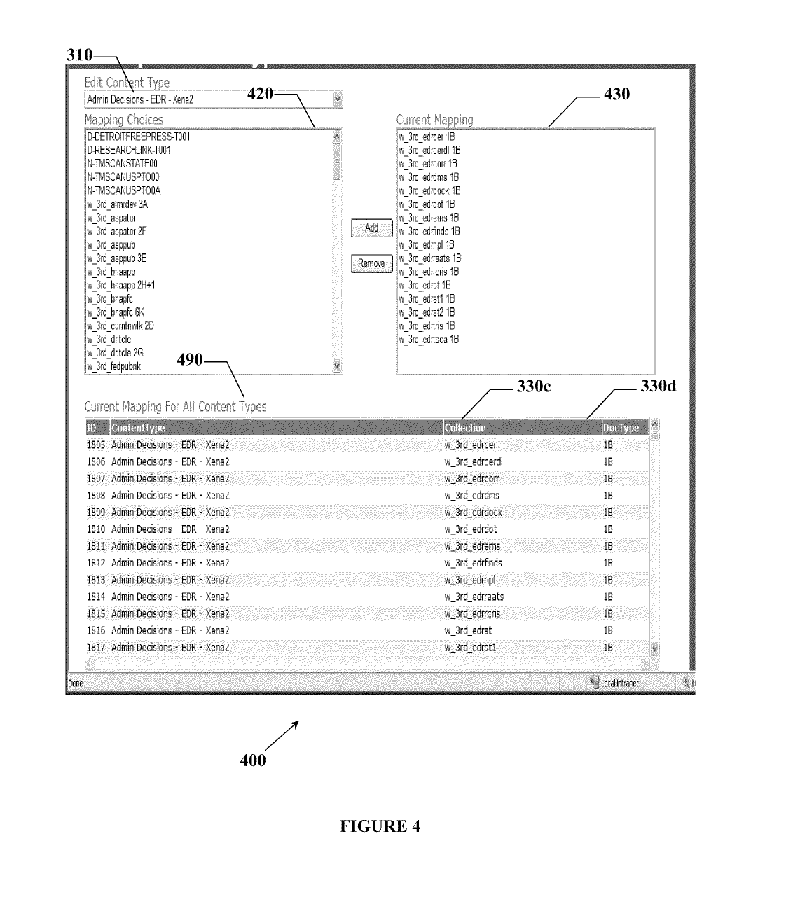

In some exemplary embodiments, a presumption is made that the content types are already defined. These content types are defined manually or programmatically by analyzing the elements of a document to see if there are similarities in other electronic files. These similarities allow for grouping certain electronic files into a content type. The electronic files grouped within a content type do not have to reside within the same collection or database. When the electronic files are being processed, mapping elements are identified and extracted 230. These mapping elements assist in mapping the electronic file to a content type. For example, in FIG. 4, a document that is being processed has a collection name 330c of “w_{—}3^{rd}_edrcer” and a doctype ID 330d “1B.” For this document, the mapping elements are the collection name 330c and the doctype ID 330d. The doctype ID 330d is generated by inspecting data known to reside within the document. The collection name 330c describes which collection/database 112 the document resides in. In another exemplary embodiment, one content type can overlap another content type. This occurs when the same mapping elements reside in several content types. Therefore several content types can be related to one another creating a cluster of associated content types.

Once all the electronic files have been analyzed, a listing of possible mapping choices is displayed to the user 420. An example of a mapping choice is the combination of the collection name followed by the doc type ID. The user selects a Content Type from the top of the interface 410 and a listing of all available mapping choices is displayed in the top left pane 420 and the currently selected mapping choices in the top right pane 430. The user has selected “Admin Decisions-EDR-Xena2” for the content type 310. Once the content type is selected, the current mapping pane populates any mapping choices that any user has previously added and the mapping choices pane populates any remaining mapping choices that the user may want to add. This exemplary interface allows the user to add available mappings or remove a mapping that exists for the selected content type. One exemplary consideration when adding/removing a mapping is taking into account whether this group of electronic files can be displayed using a single stylesheet. In addition, the bottom pane 490 allows the user to view the current mapping for all content types.

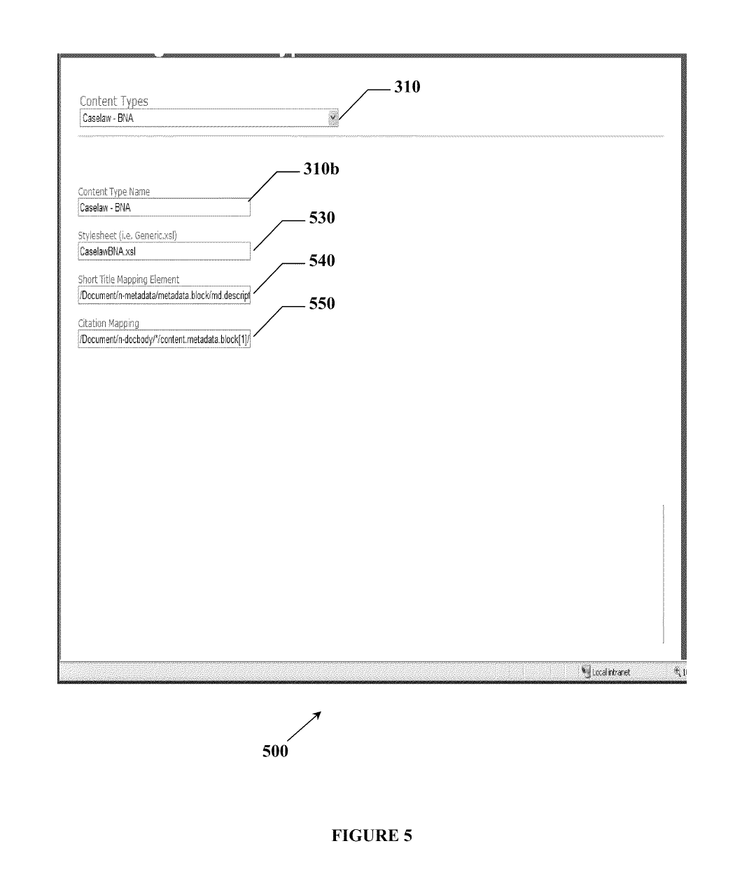

In other exemplary embodiments, the content type has to be added or edited. To add or edit a content type, user interface FIG. 5 illustrates information that is potentially added/edited to the content type. Here content type “Caselaw-BNA” 310 is being edited. Element fields are populated or edited depending on the situation. Examples of element fields include are not limited to the content type name 310b, the stylesheet file 310d, the location of the short title mapping element 310c and the citation mapping 310e. The short title mapping element 310c provides the user with a set of patterns that locates short titles of electronic files that reside within the content type. The citation mapping 310e location provide's the user with a set of patterns that locates the citation in the electronic files that reside within the content type.

One of ordinary skill in the art would recognize and appreciate various other embodiments regarding the exemplary process flow 200. An exemplary embodiment includes executing two or more tasks in parallel using multiple processors or processor-like devices or a single processor organized as two or more virtual machines or sub processors. Another example alters the process sequence or provides different functional partitions to achieve analogous results. For instance, some embodiments may alter the client-server allocation of functions, such that functions shown and described on the server side are implemented in whole or in part on the client side, and vice versa. Moreover, still other embodiments implement the tasks as two or more interconnected hardware modules with related control and data signals communicated between and through the modules. Thus, the exemplary process flow (in FIG. 2 and elsewhere in this description) applies to software, hardware, and firmware implementations.

### Exemplary Interfaces for Analyzing Electronic Files

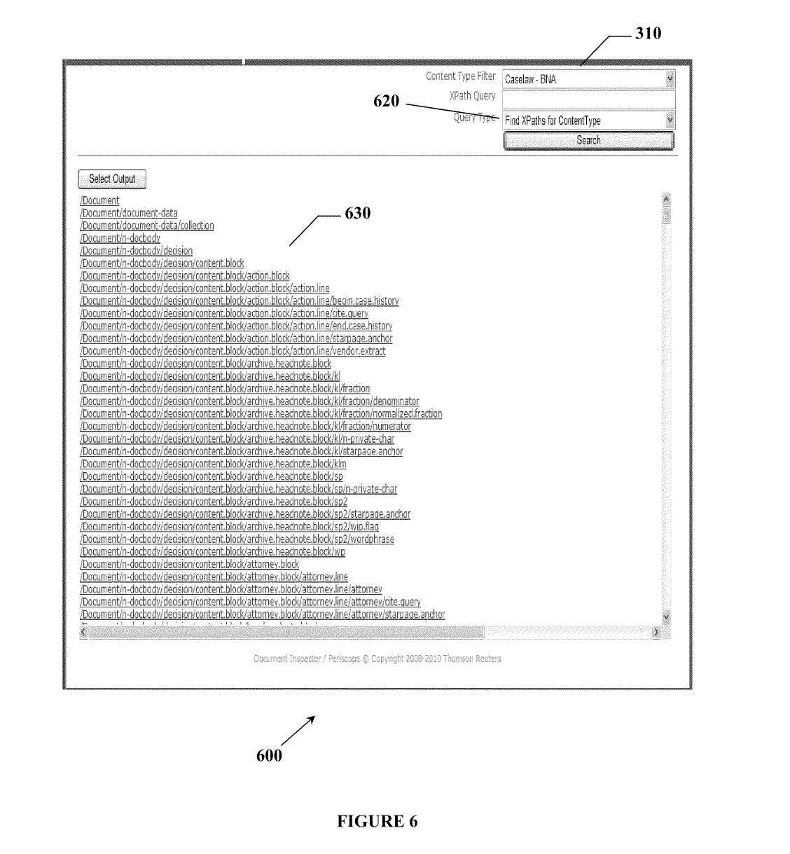

Once the mapping of the patterns, electronic files, mapping elements and content types are stored within the database 1141, a user is able to query 285 against that database 1141. FIGS. 6-10 illustrate exemplary graphical user interfaces 290 wherein the user has several criteria to choose from when trying to query 285 the database 1141. While the criteria assist the user to narrow down his/her results, entering criteria is not a necessity. If no criterion is selected, the results are displayed in a default format such as pattern listing or GUID listing. Specifically, in FIG. 6, the user has selected the content type 310 “Caselaw-BNA” and a query type 620 “Find XPaths for ContentType” for his/her query. The user wants the query to render all patterns/XPaths within the Caselaw-BNA content type 630. Note that in this example, only unique patterns are listed. As noted earlier, the results could display the number of times this patterns is present within the content type selected. In addition, the user clicks on the hyperlinked pattern to display the list of document GUIDs that contain the pattern clicked on.

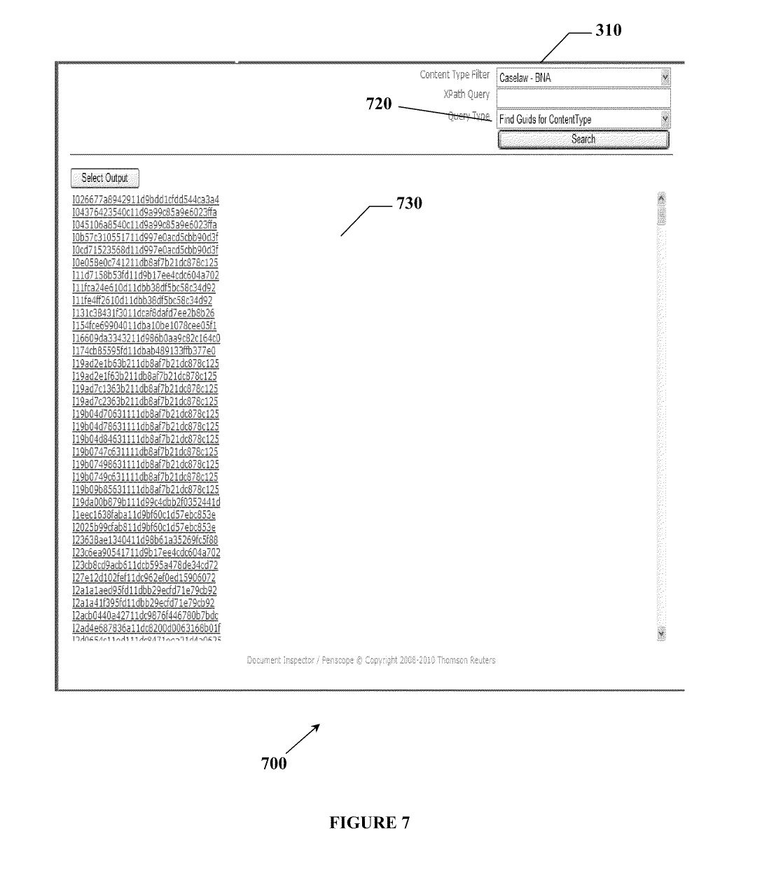

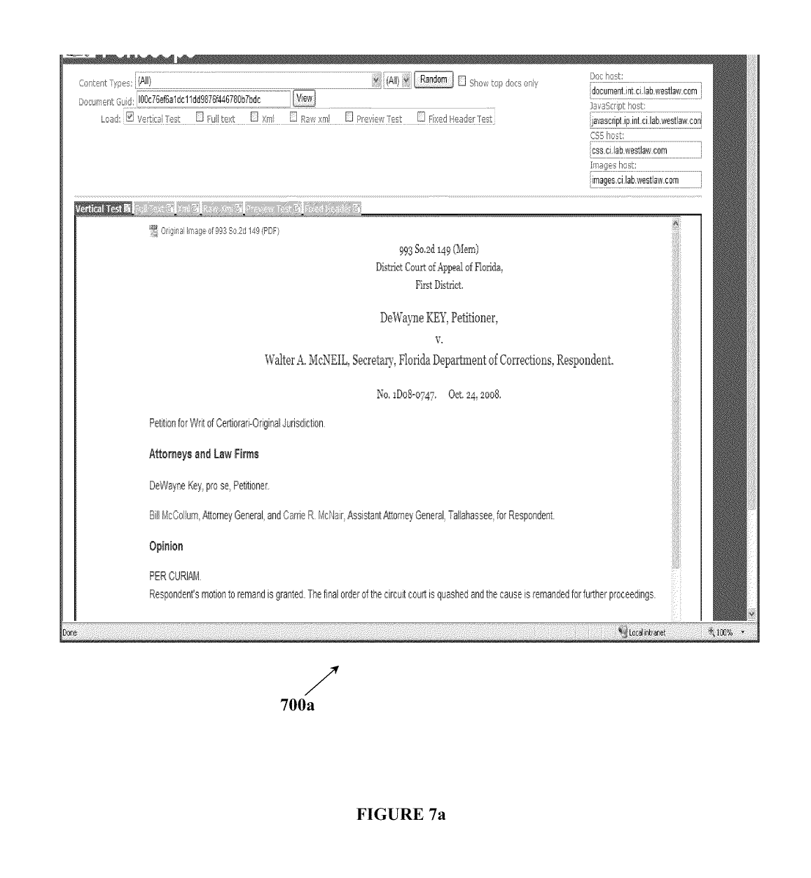

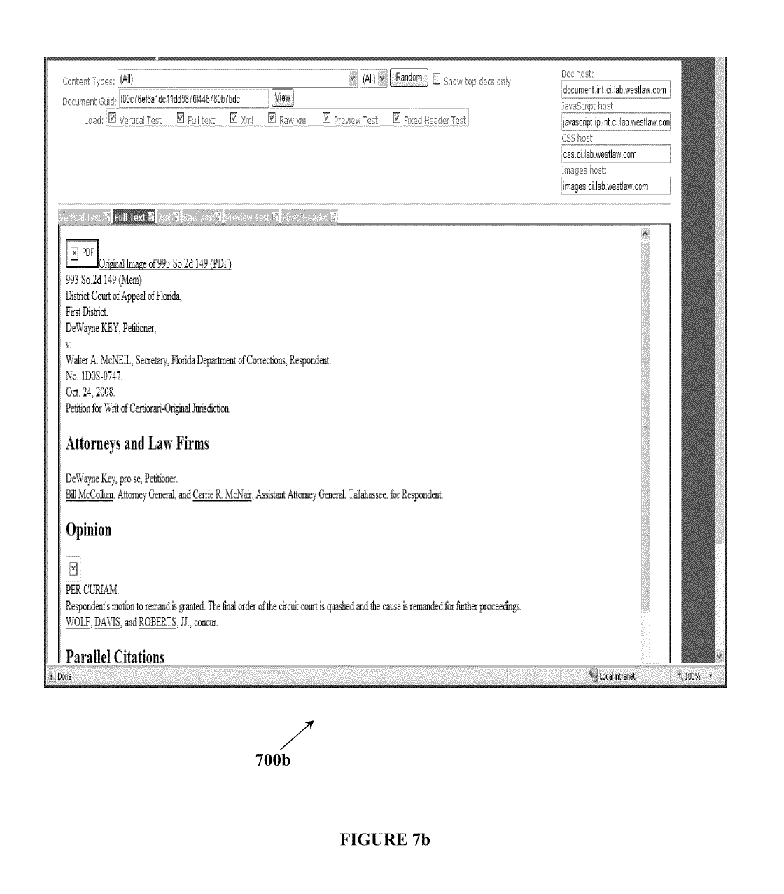

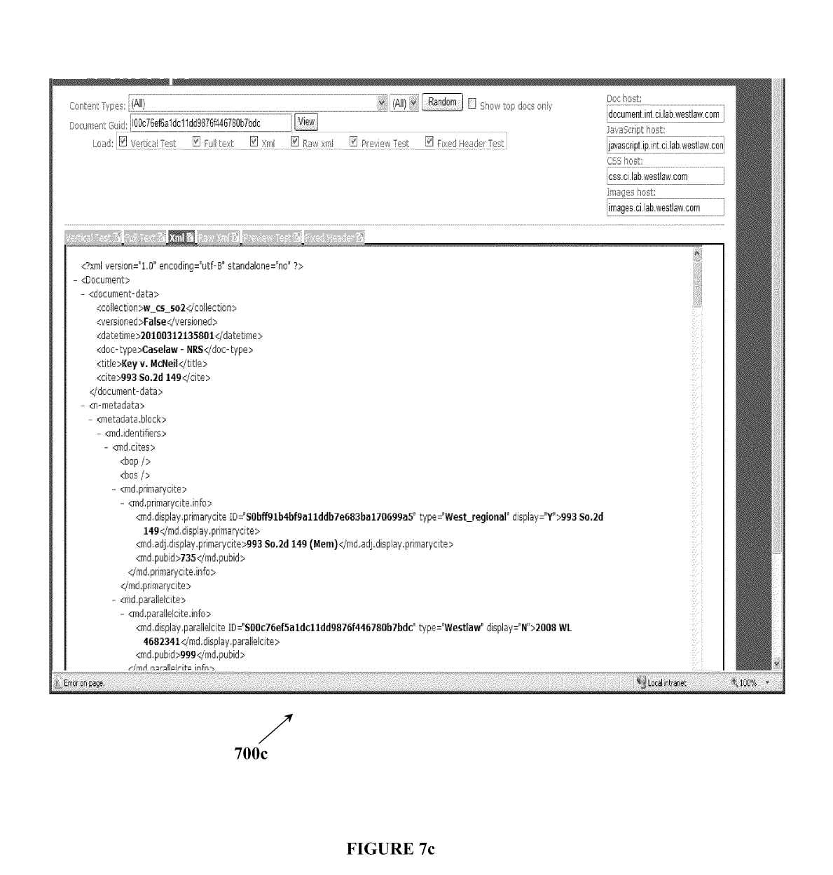

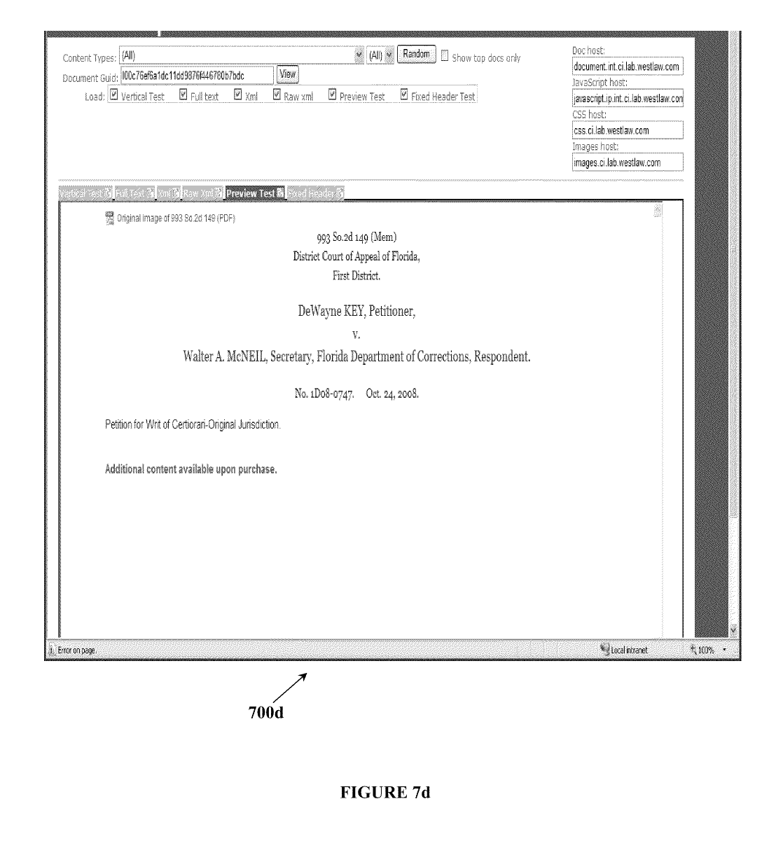

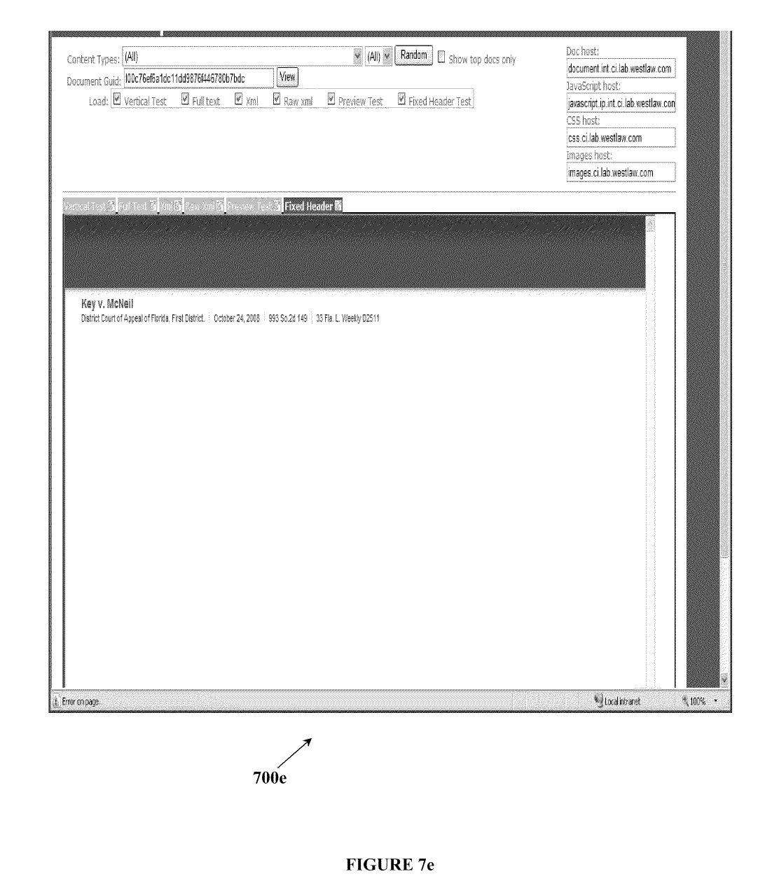

Another exemplary interface FIG. 7 shows the user selected “Caselaw-BNA” for ContentType 310 and “Find GUIDs for ContentType” for query type 720. These rendered results display a document GUID listing that contain that the selected ContentType 730. Here when the user clicks on any hyperlinked GUID, several different views of the document are available for review FIGS. 7a-e. This aids the user in making sure the document displays properly in any possible view (i.e. full view mode FIG. 7a, full text FIG. 7b, XML FIG. 7c, preview mode FIG. 7d, fixed header FIG. 7e, etc.). In other embodiments, additional views of the document are available for review such as reading mode, mobile view or any other view that is beneficial to a user.

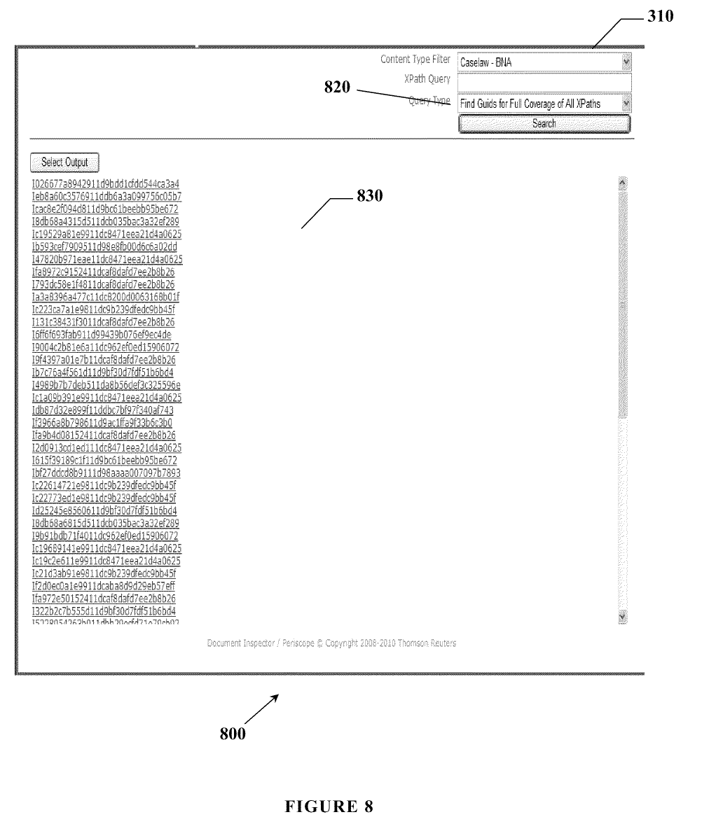

Yet another exemplary interface FIG. 8 shows the user selected “Caselaw-BNA” for ContentType 310 and “Find GUIDs for Full Coverage of All XPaths” for query type 820. These rendered results display the minimum listing of document GUIDs that covers all scenarios of XPaths/patterns 830.

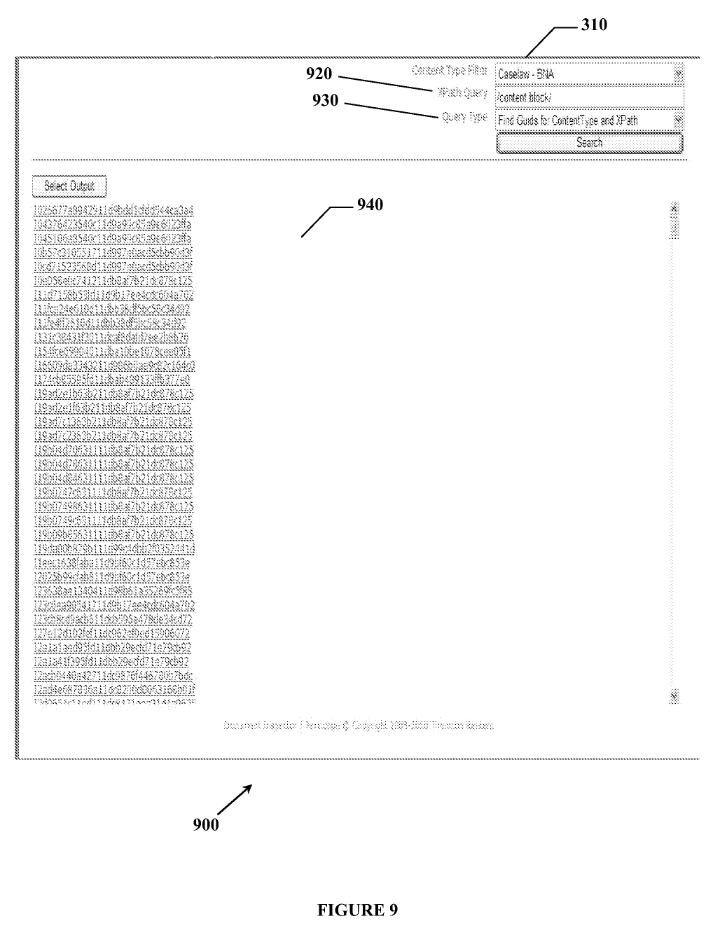

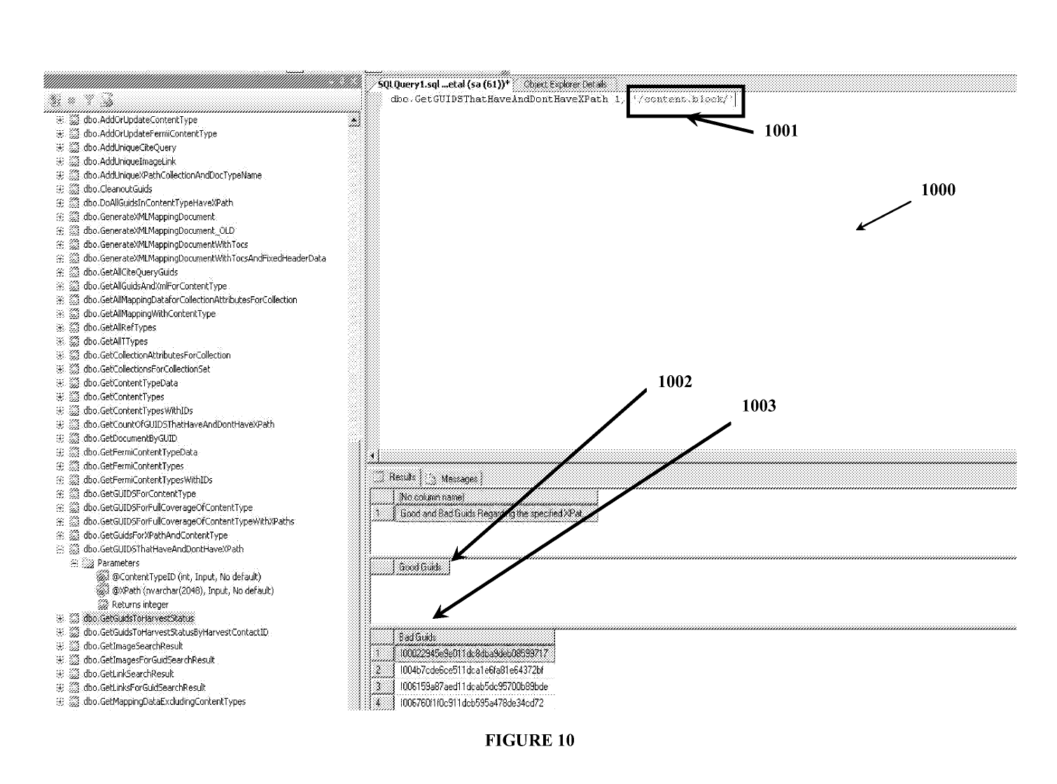

Yet another exemplary interface FIG. 9 shows the user selected “Caselaw-BNA” for ContentType 310, “/content.block/” for)(Path type 920 and “Find GUIDs for ContentType and XPath” 930. Using these criteria, the rendered results display 1040 the GUIDs that contain the sub-pattern “/content.block/.” Another query, FIG. 10, for just the sub-pattern 1001 “/content.block/,” could render two sets of results-one where the listing of GUIDs contains the sub-pattern 1002 and another listing of GUIDs that does not contain the sub-pattern 1003.

Although the present invention has been described with reference to exemplary embodiments, workers skilled in the art will recognize that changes may be made in form and detail without departing from the spirit and scope of the invention.

What is being claimed is:

1. A computer-implemented method for analyzing electronic files comprising:
a. receiving at least one electronic file, wherein the least one electronic file is associated with at least one pattern;
b. determining if the at least one pattern is recognized and;
i. if not, creating a record for at least one unrecognized pattern, including relating the at least one unrecognized pattern to at least one associated electronic file, within a storage mechanism; and
ii. if so, relating at least one recognized pattern to at least one associated electronic file within the storage mechanism;
c. querying the storage mechanism based on at least one criteria;
d. generating a signal associated with a set of results based on the at least one criteria; and
e. transmitting the signal associated with the set of results.

2. The method of claim 1 wherein two or more electronic files are disparate.

3. The method of claim 1 wherein the at least one unrecognized pattern and the at least one recognized pattern comprises a hierarchical structure.

4. The method of claim 3 wherein the hierarchical structure is XML.

5. The method of claim 1 wherein the storage mechanism is a database.

6. The method of claim 1 wherein the at least one criteria includes at least one content type.

7. The method of claim 6 wherein the at least one criteria includes at least one pattern query.

8. The method of claim 6 wherein the at least one criteria includes at least one query type.

9. The method of claim 7 wherein the at least one query type includes but is not limited to all unique patterns for a content type, all document identifiers for a content type, all document identifiers for content type and a unique pattern, and all document identifiers that cover all unique patterns.

10. A system for analyzing electronic files comprising:
a. a server, the server including a processor and a memory;
b. means for receiving at least one electronic file via the server, wherein the least one electronic file is associated with at least one pattern;
c. means for determining the at least one pattern is not recognized and, in response to the means for determining the at least one pattern is not recognized, creating a record for at least one unrecognized pattern, the at least one unrecognized pattern relating to at least one associated electronic file, within a storage mechanism;
d. means for determining the at least one pattern is recognized and, in response to the means for determining the at least one pattern is recognized, relating at least one recognized pattern to at least one associated electronic file within the storage mechanism;
e. means for querying the storage mechanism based on at least one criteria;
f. means for generating a signal associated with a set of results based on the at least one criteria; and
g. means for transmitting the signal associated with the set of results.

11. The system of claim 10 wherein two or more electronic files are disparate.

12. The system of claim 10 wherein the unrecognized pattern and the recognized pattern comprises a hierarchical structure.

13. The system of claim 12 wherein the hierarchical structure is XML.

14. The system of claim 10 wherein the storage mechanism is a database.

15. The system of claim 9 wherein the at least one criteria includes at least one content type.

16. The system of claim 15 wherein the at least one criteria includes at least one pattern query.

17. The system of claim 15 wherein the at least one criteria includes at least one query type.

18. The system of claim 17 wherein the at least one query type includes but is not limited to all unique patterns for a content type, all document identifiers for a content type, all document identifiers for content type and a unique pattern, and all document identifiers that cover all unique patterns.
